(19) United States
(12) Patent Application Publication
(10) Pub. No.: US 2022/0352542 A1
(43) Pub. Date: Nov. 3, 2022

(54) METHOD OF PRODUCING A SECONDARY BATTERY, AND SECONDARY BATTERY

(71) Applicant: KABUSHIKI KAISHA TOSHIBA, Tokyo (JP)

(72) Inventors: Yuiko KOITABASHI, Yokohama (JP); Taro FUKAYA, Tokyo (JP); Yasuhiro HARADA, Isehara (JP); Norio TAKAMI, Yokohama (JP)

(73) Assignee: KABUSHIKI KAISHA TOSHIBA, Tokyo (JP)

(21) Appl. No.: 17/650,432

(22) Filed: Feb. 9, 2022

(30) Foreign Application Priority Data
Apr. 27, 2021 (JP) 2021-075087

(51) Int. Cl. H01M 10/0525; H01M 4/485; H01M 4/525; H01M 10/44; H01M 10/0562

(52) U.S. Cl. CPC H01M 10/0525; H01M 4/485; H01M 4/525; H01M 10/446; H01M 10/0562; H01M 2300/0068

(57) ABSTRACT

According to one embodiment, a method of producing a secondary battery includes preparing a battery architecture, which includes a positive electrode, a negative electrode, and an electrolyte, providing a potential adjusted state by adjusting a positive electrode potential to 4.3 V to 4.8 V and a negative electrode potential to 0.5 V to 1.1 V based on oxidation-reduction potential of lithium, and holding the battery architecture in the potential adjusted state. The positive electrode includes a nickel-containing oxide represented by a general formula LiₓM1O₂. M1 is a metal element including at least Ni in an elemental ratio of 50% or more, and 0<x≤1. The negative electrode includes a titanium-containing oxide. The electrolyte includes a sulfur-containing compound.

### CROSS-REFERENCE TO RELATED APPLICATIONS

This application is based upon and claims the benefit of priority from Japanese Patent Application No. 2021-075087, filed Apr. 27, 2021, the entire contents of which are incorporated herein by reference.

### FIELD

Embodiments described herein relate generally to a method of producing a secondary battery, and a secondary battery.

### BACKGROUND

Recently, secondary batteries, such as a nonaqueous electrolyte secondary battery like a lithium ion secondary battery, have been actively researched and developed as a high energy-density battery. The secondary batteries, such as a nonaqueous electrolyte secondary battery, are anticipated as a power source for vehicles such as hybrid electric automobiles, electric cars, an uninterruptible power supply for base stations for portable telephones, or the like. Therefore, the secondary battery is demanded to, in addition to having a high energy density, be excellent in other performances such as rapid charge-discharge performances and long-term reliability, as well.

Commercialized nonaqueous electrolyte secondary batteries include, for example, a secondary battery that uses a lithium-transition metal composite oxide containing Co, Mn, Ni, or the like as a positive electrode active material, and a carbonaceous material or a titanium-containing oxide as a negative electrode active material.

It is known that as the secondary battery is repeatedly used, the positive electrode active material or the negative electrode active material is deteriorated, whereby there is progression in deterioration of the secondary battery such as a decrease in capacity. One example of causes of the deterioration include the reaction between the active material and an electrolytic solution (liquid electrolyte). One method of suppressing the reaction, for example, is a technique of forming a coating on the surface of the active material, whereby the coating prevents the decomposition (side reaction) of the electrolytic solution to thereby suppress the deterioration of the battery characteristics. A secondary battery capable of suppressing deterioration of battery performance even in high temperature environments have been conventionally in demand.

Techniques are known in which, a protective coating is formed on the surface of the electrode, for example, the surface of an electrode active material-containing layer, in order to suppress side reactions between the electrolytic solution and electrode included in the secondary battery. The battery life can be improved by inhibiting the side reactions. There is a tendency for the electrolytic solution and the electrolyte salt to become decomposed whereby gas is generated, thereby making the life performance of the secondary battery is inferior, in such a case where the thickness and uniformity of the protective coating are insufficient, though this also depends on the composition of the protective coating. Furthermore, in the case where the protective coating is too thick, there is typically a tendency for the problem of increase in resistance to arises, making the input/output characteristics deteriorate, whereby the capacity ends up decreasing as a result.

### BRIEF DESCRIPTION OF THE DRAWINGS

FIG. 1 is a cross-sectional view schematically illustrating an example of a battery architecture according to an embodiment;

FIG. 2 is an enlarged cross-sectional view of section A of the battery architecture shown in FIG. 1;

FIG. 3 is a partially cutaway perspective view schematically illustrating another example of the battery architecture according to the embodiment;

FIG. 4 is an enlarged cross-sectional view of section B of the battery architecture shown in FIG. 3;

FIG. 5 is a cross-sectional view schematically illustrating yet another example of the battery architecture according to the embodiment; and

FIG. 6 is a schematic cross-sectional view along line VI-VI of the battery architecture shown in FIG. 5.

### DETAILED DESCRIPTION

According to one embodiment, a method of producing a secondary battery includes preparing a battery architecture, which includes a positive electrode, a negative electrode, and an electrolyte, providing a potential adjusted state by adjusting a positive electrode potential of the positive electrode to a range of 4.3 V or more and 4.8 V or less based on oxidation-reduction potential of lithium and adjusting a negative electrode potential of the negative electrode to a range of 0.5 V or more and 1.1 V or less based on oxidation-reduction potential of lithium, and holding the battery architecture in the potential adjusted state. The positive electrode includes a nickel-containing oxide represented by a general formula LiₓM1O₂. M1 is a metal element including at least Ni in an elemental ratio of 50% or more, and 0<x≤1. The negative electrode includes a titanium-containing oxide. The electrolyte includes a sulfur-containing compound.

According to another embodiment, a secondary battery, which is produced by the production method according to the above embodiment, is provided.

Hereinafter, embodiments will be described with reference to the drawings. The same reference signs are applied to common components throughout the embodiments and overlapped explanations are thereby omitted. Each drawing is a schematic view for encouraging explanations of the embodiment and understanding thereof, and thus there are some details in which a shape, a size and a ratio are different from those in a device actually used, but they can be appropriately design-changed considering the following explanations and known technology.

### First Embodiment

According to a first embodiment, a method of producing a secondary battery is provided. The method includes preparing a battery architecture, providing a potential adjusted state, and holding the battery architecture in the potential adjusted state. The battery architecture includes a positive electrode, a negative electrode, and an electrolyte. The positive electrode includes a nickel-containing oxide. The nickel-containing oxide is represented by a general formula LiₓM1O₂. In the general formula of the nickel-containing oxide, M1 is a metal element including at least 50% or more of Ni in elemental ratio, and 0<x≤1. The negative electrode includes a titanium-containing oxide. The electrolyte includes a sulfur-containing compound. The potential adjusted state is provided by adjusting a positive electrode potential of the positive electrode to a range of 4.3 V or more and 4.8 V or less based on oxidation-reduction potential of lithium and adjusting a negative electrode potential of the negative electrode to a range of 0.5 V or more and 1.1 V or less based on oxidation-reduction potential of lithium.

Examples of a method for forming a protective film on the surface of an electrode for stabilizing the performance of a secondary battery such as a nonaqueous electrolyte battery include a treatment of performing aging or reacting an additive added to an electrolyte. When such a treatment is performed at a high temperature and in a high charged state (for example, a high State of Charge: high SOC), decomposition of the electrolyte is apt to occur simultaneously with film formation, and gas generation and shifting in potential may occur. When the treatment is performed at a low temperature or low SOC so as to avoid such a situation, decomposition of the electrolyte is suppressed; however, film formation may be insufficient. In this case, the advantage of the film may not be fully utilized, whereby the battery performance would not be sufficiently exhibited. For example, when the effect of suppressing the decomposition of the electrolyte by the film cannot be obtained, the battery resistance may increase due to the decomposition of the electrolyte every time charge-and-discharge is performed.

In the method of producing the secondary battery according to the first embodiment, by including a posttreatment of holding a battery architecture in a potential adjusted state in which a positive electrode potential is adjusted to 4.3 V or more and 4.8 V or less (vs. Li/Li⁺) and a negative electrode potential is adjusted to 0.5 V or more and 1.1 V or less (vs. Li/Li⁺) after preparing the battery architecture corresponding to a precursor of the secondary battery, a film can be formed to an extent that an effect can be exhibited while decomposition of an electrolyte is suppressed. This posttreatment corresponds to so-called aging.

The positive electrode potential and the negative electrode potential in the potential adjusted state may correspond to potential ranges respectively reached by the positive electrode and the negative electrode in a charge state higher than an operation range of charge-and-discharge of a battery using a nickel-containing oxide for an active material of the positive electrode and a titanium-containing oxide for an active material of the negative electrode. In other words, the potential adjusted state may correspond to a state of charge beyond a fully charged state, that is, an overcharged state.

The film formation by the posttreatment tends to occur mainly on the surface of the positive electrode. A small amount of film may also be formed on the surface of the negative electrode. The positive electrode surface as used herein may be, for example, a surface of a positive electrode active material-containing layer described later. Similarly, the negative electrode surface may be, for example, a surface of a negative electrode active material-containing layer described later.

The film is considered to be one that may be generated, for example, by metal ions present in the electrolyte and a sulfur-containing compound included in the electrolyte reacting at the surfaces of the electrode active material-containing layers. Examples of metal ions are nickel included in the positive electrode, cobalt and manganese which may be included in the positive electrode, or niobium which may be included in the negative electrode. The niobium that may be included in the negative electrode may be niobium included in niobium titanium composite oxide, which is one example of the titanium-containing oxide included as a negative electrode active material. By at least partially covering the active material surface(s) with a film of such form, the active material surface (s) is modified, whereby the reaction between the active material(s) and the electrolyte can be inhibited. As a result, the gas generation can be suppressed, and excellent life performance can be exhibited even in a high-temperature environment. The high-temperature environment is, for example, an environment at 45° C. to 80° C.

The battery architecture includes a positive electrode, a negative electrode, and an electrolyte. Respective details of the positive electrode, negative electrode, and electrolyte will be described later. The battery architecture may further include a separator disposed between the positive electrode and the negative electrode. The negative electrode, positive electrode, and separator may configure an electrode group. The electrolyte may be held in the electrode group.

In addition, the battery architecture may further include a container member housing the electrode group and the electrolyte.

Furthermore, the battery architecture may further include a negative electrode terminal electrically connected to the negative electrode and a positive electrode terminal electrically connected to the positive electrode.

The battery architecture can be prepared, for example, by housing a positive electrode, a negative electrode, and an electrolyte in a container member. A method of producing the positive electrode, a method of producing the negative electrode, and a method of adjusting the electrolyte will be described later. It is desirable to prepare the battery architecture under an inert atmosphere. In addition, it is desirable to prepare the battery architecture under a dry environment. Adopting an inert atmosphere or a dry environment can avoid, potential gas sources like oxygen, carbon dioxide, and hydrogen. Production of the positive and negative electrodes and adjustment of the electrolyte are also desirably performed in an inert atmosphere and a dry environment. Examples of the inert atmosphere include an argon atmosphere.

An aspect of the electrode group is not particularly limited, and the electrode group may have, for example, a wound structure or a stacked structure.

The electrode group having a wound structure can be fabricated, for example, as follows. The positive electrode and the negative electrode are stacked with the separator interposed therebetween to obtain a stack of the positive electrode, the negative electrode, and the separator. The stack is wound, and then the obtained wound body is further pressed, whereby a flat-shaped wound electrode group can be prepared.

The electrode group having a stacked structure can be fabricated, for example, by stacking positive electrodes, negative electrodes, and separator(s) such that the separator (s) is interposed between the positive electrode and the negative electrode. Herein, plural separators may be arranged between the positive electrodes and the negative electrodes, or one separator may be folded, for example, in zigzag, and the positive electrodes and the negative electrodes may be alternately arranged in spaces formed by fold-backs of the separator.

When using a container member made of a laminate film, temporary sealing can be performed by, for example, closing an opening by thermal fusion. In temporary sealing, for example, a position further outward from a position where full sealing is to be performed for the secondary battery as a finished product (a position closer to the opening end portion) is closed by thermal fusion.

When the metal container is used as the container member, temporary sealing can be performed, for example, by closing an injection port for introducing the electrolyte, provided outside the container, with a sealing plug. The injection port can be provided, for example, in a lid body of the metal container such as a sealing plate. For example, a liquid electrolyte is put into the metal container through the injection port, and then a rubber plug is attached to the injection port to perform temporary sealing.

The aspect of performing temporary sealing is not limited to the above example.

The adjustment of the positive and negative electrode potentials to the potential adjusted state can be performed, for example, by subjecting the temporarily sealed battery architecture to initial charge-and-discharge and then charging again. Alternatively, initial charge or initial charge-and-discharge may be performed so as to directly bring the battery architecture into the potential adjusted state. Charge and discharge are performed so that an appropriate state of charge (SOC) is obtained, so as to bring the potential of each of the positive electrode and the negative electrode into the above-mentioned potential ranges in the potential adjusted state. The SOC can be adjusted based on, for example, the battery voltage. Initial charge-and-discharge is performed to an appropriate SOC according to the active material used for each of the positive electrode and the negative electrode and the design of each electrode, to thereby bring the battery architecture into the potential adjusted state.

Alternatively, before assembling the battery architecture, a potential adjusted state can be obtained by performing charge-and-discharge for each of the positive electrode and the negative electrode, individually. For example, a positive electrode and a counter electrode made of lithium metal may be used to assemble a battery (e.g., a half cell), thereby allowing adjustment of the positive electrode potential. In a similar manner, for example, a negative electrode and a counter electrode made of lithium metal may be used to assemble a battery (e.g., a half cell), thereby allowing adjustment of the negative electrode potential. The positive electrode and the negative electrode with the potential thereof adjusted respectively are used to produce a battery architecture, whereby a battery architecture in a potential adjusted state can be provided.

A specific example of a method of adjusting the battery architecture to a potential adjusted state will be described. In this example, there will be described a method of preparing a battery architecture including a positive electrode using a lithium-nickel-cobalt-manganese composite oxide represented by LiNi_{0.8}Co_{0.1}Mn_{0.1}O₂ as a positive electrode active material and a negative electrode using Nb₂TiO₇ as a negative electrode active material, and performing charge-and-discharge of this battery architecture to adjust the positive and negative electrode potentials to the potential adjusted state.

The positive electrode and the negative electrode described above are housed in a container member together with an electrolyte to which a sulfur-containing compound is added, and the container member is temporarily sealed to prepare a battery architecture. The battery architecture is subjected to initial charge-and-discharge under the following conditions. The battery architecture is charged at a constant current of 0.2 C at 25° C. to a battery voltage of 3 V, and then charged at a constant voltage of 3 V. Constant voltage charge is performed until the total time of constant current charge and constant voltage charge reaches 10 hours. Through the initial charge in the constant-current constant-voltage mode (CCCV mode), a positive electrode potential may become 4.2 V (vs. Li/Li⁺) and a negative electrode potential may become 1.2 V (vs. Li/Li⁺) in the battery architecture of this example. In this example, the SOC reached by the above CCCV charge is considered 100%. After the above initial charge, the battery architecture is discharged at a constant current of 0.2 C at 25° C. until the battery voltage reaches 1.5 V to perform initial discharge. In this example, the SOC reached by the above constant current discharge is considered 0%. The current value during constant current charge and constant current discharge is represented in units where 1 C represents a current value at which the SOC becomes 0% in one hour when the battery is discharged from the SOC of 100%.

Thereafter, the battery architecture is charged at a constant current of 0.2 C at 25° C. to a battery voltage of, for example, 3.3 V. Subsequently, charge is further performed at a constant voltage of 3.3 V reached by constant the current charge until the current value becomes 1/20 C. The battery architecture is subjected to this constant-current constant-voltage charge (CCCV), whereby the positive electrode potential may become 4.4 V (vs. Li/Li⁺) and the negative electrode potential may become 1.1V (vs. Li/Li⁺) in the battery architecture of this example. The SOC reached by this condition is 120%. That is, the potential adjusted state that is the overcharged state is obtained.

During posttreatment, holding the battery architecture in the potential adjusted state is preferably performed at a temperature of 60° C. or less. The temperature for holding the battery architecture in the potential adjusted state is more preferably 45° C. or less. By performing the treatment for holding the potential adjusted state at a relatively low temperature, decomposition of the electrolyte can be further suppressed. In view of the film-forming reaction, the temperature of performing the treatment is preferably 25° C. or more.

The time for holding the battery architecture in the potential adjusted state is preferably 72 hours or less. By restricting the upper limit of the holding time to 72 hours, excessive film formation and decomposition of the electrolyte can be avoided. The holding time is more preferably 24 hours or less. The holding time is preferably 3 hours or more, more preferably 6 hours or more, and still more preferably 12 hours or more. With longer holding time, there tends to exhibited a more significant effect of suppressing the decomposition of the electrolyte by the film, thereby leading to the improvement of the life performance of the secondary battery.

The holding temperature for holding the potential adjusted state in the posttreatment can be controlled, for example, by placing the battery architecture at the potential adjusted state in a thermostatic bath set at a predetermined temperature. In addition, when the holding temperature is controlled by using a thermostatic bath, the time point at which the battery architecture is placed in the thermostatic bath is defined as the start time of the holding time, and the time point at which the battery architecture is taken out from the thermostatic bath is defined as the end time of the holding time.

The temporary seal is opened, and the gas generated by the posttreatment is released. After degassing, the container member is fully sealed to provide a secondary battery. For example, the battery architecture taken out from the thermostatic bath is cooled to room temperature, then the battery architecture is placed in an inert atmosphere, and the temporary sealing is opened. The container member is fully sealed under a reduced pressure environment, whereby a secondary battery can be provided. Alternatively, the temporary sealing may be opened under a reduced pressure environment, and then the container member is fully sealed to thereby provide a secondary battery. The reduced pressure environment herein refers to, for example, a vacuum state of about −90 kPa.

When a container member made of a laminate film is used, opening the sealing can be performed, for example, by cutting open the container member at the position where temporary sealing was performed, or by cutting away the portion of the container member where temporary sealing was performed. The full sealing of the container member made of the laminate film can be performed, for example, by closing the opening, which had resulted from opening of the seal, by thermal fusion. The full sealing of the container member is desirably performed at a position further inside from the position where the temporary sealing was performed (a position farther from the opening end portion).

When the metal container is used as the container member, for example, the sealing plug used for temporary sealing may be removed to open the seal. The metal container can be fully sealed, for example, by welding a sealing plug made of a material capable of being welded to the container to the opening (for example, an electrolyte injection port) that had resulted from unplugging.

After the posttreatment, charge-and-discharge may be performed to adjust the secondary battery to a state of charge for shipment. Charge-and-discharge to the shipment state may be performed, for example, before opening the temporary sealing and degassing, or may be performed after fully sealing the secondary battery. In addition, after full sealing, capacity examination by charge-and-discharge of the secondary battery for quality examination as a product, or break-in charge-and-discharge of the secondary battery may also be performed.

Hereinafter, the positive electrode, the negative electrode, the electrolyte, the separator, the container member, the negative electrode terminal, and the positive electrode terminal will be described in detail.

(1) Positive Electrode

The positive electrode includes a nickel-containing oxide represented by the general formula LiₓM1O₂ as a positive electrode active material. In the above general formula, M1 is a metal element including at least Ni at an elemental ratio of 50% or more. In addition, the subscript x in the general formula is within the range of 0<x≤1.

The positive electrode may include a positive electrode active material-containing layer containing the positive electrode active material. The positive electrode may further include a positive electrode current collector.

The positive electrode active material-containing layer may be formed on one face or both the front and reverse faces of the positive electrode current collector. The positive electrode active material-containing layer may optionally contain an electro-conductive agent and a binder, in addition to the positive electrode active material.

Specific examples of the nickel-containing oxide include lithium nickel composite oxide (for example, a compound represented by LiₓNiO₂ wherein 0<x≤1), the lithium nickel cobalt composite oxide (for example, a compound represented by LiₓNi_{1-y}Co_{y}O₂ wherein 0<x≤1 and 0<y≤0.5), and the lithium-nickel-cobalt-manganese composite oxide (for example, a compound represented by LiₓNi_{1-z-w}Co_{z}Mn_{w}O₂ wherein 0<x≤1, 0<z<0.5, 0<w<0.5, and z+w≤0.5).

The positive electrode active material may singly include one of the above nickel-containing oxides, or may include a combination of two or more.

The positive electrode active material may further include another compound in addition to the nickel-containing oxide. Herein, for convenience, the nickel-containing oxide is referred to as a first positive electrode active material, and another compound as positive electrode active material is referred to as a second positive electrode active material. The positive electrode active material may include one or more of first positive electrode active materials and one of a second positive electrode active material in combination, or may include one or more of first positive electrode active materials and two or more of second positive electrode active materials in combination. The positive electrode active material includes the first positive electrode active material (the nickel-containing oxide) in a proportion of, for example, 50% by mass or more, and preferably 80% by mass or more. The positive electrode active material may also include only the first positive electrode active material (the nickel-containing oxide).

Examples of the second positive electrode active material include manganese dioxides (MnO₂), iron oxides, copper oxides, nickel oxides, lithium manganese composite oxides (e.g., a compound represented by LiₓMn₂O₄ or LiₓMnO₂, wherein 0<x≤1), lithium cobalt composite oxides (e.g., a compound represented by LiₓCoO₂, wherein 0<x≤1), lithium manganese cobalt composite oxides (e.g., a compound represented by LiₓMnᵥCo₁₋ᵥO₂, wherein 0<x≤1 and 0<v≤1), lithium manganese nickel composite oxides having a spinel structure (e.g., a compound represented by LiₓMn₂₋ₛNiₛO₄, wherein 0<x≤1 and 0<s<2), lithium phosphates having an olivine structure (e.g., a compound represented by LiₓFePO₄, wherein 0<x≤1; a compound represented by LiₓFe₁₋ₜMnₜPO₄, wherein 0<x≤1 and 0<t≤1; and a compound represented by LiₓCoPO₄, wherein 0<x≤1), iron sulfates (Fe₂(SO₄)₃), vanadium oxides (e.g., V₂O₅), and a compound represented by LiₓNi₁₋ⱼ₋ₖCoⱼMnₖO₂ wherein 0<x≤1, 0.5<j<1, 0.5<k<1, and 0.5<j+k≤1 (lithium-nickel-cobalt-manganese composite oxides including less than 50% of Ni in elemental ratio among the metal elements).

When a room temperature molten salt is used as the electrolyte of the battery, it is preferable to use a positive electrode active material including lithium iron phosphate, a compound represented by LiᵢVPO₄F wherein 0≤i≤1, lithium manganese composite oxide, lithium nickel composite oxide, lithium nickel cobalt composite oxide, or a mixture thereof. Since these compounds have low reactivity with room temperature molten salts, cycle life can be improved. Details regarding the room temperature molten salt are described later.

The primary particle diameter of the positive electrode active material is preferably from 100 nm to 1 μm. The positive electrode active material having a primary particle size of 100 nm or more is easy to handle during industrial production. In the positive electrode active material having a primary particle size of 1 μm or less, in-solid diffusion of lithium ions can proceed smoothly.

The specific surface area of the positive electrode active material is preferably from 0.1 m²/g to 10 m²/g. The positive electrode active material having a specific surface area of 0.1 m²/g or more can secure sufficient sites for inserting and extracting Li ions. The positive electrode active material having a specific surface area of 10 m²/g or less is easy to handle during industrial production, and can secure a good charge-discharge cycle performance.

Here, for the measurement of the specific surface area, a method is used by which molecules, for which an occupied area in adsorption is known, are adsorbed onto the surface of powder particles at a temperature of liquid nitrogen, and the specific surface area of the sample is determined from the amount of adsorbed molecules. The most commonly used is the BET method based on low-temperature and low-humidity physical adsorption of an inert gas. The BET method is based on the BET theory, which is the most famous theory as a method of calculating the specific surface area where the Langmuir theory, which is a monomolecular layer adsorption theory, has been extended to multi-molecular layer adsorption. The specific surface area determined by the above method is referred to as a “BET specific surface area”.

The electro-conductive agent is added to enhance the current collection performance of the positive electrode active material and to suppress contact resistance between the positive electrode active material and the positive electrode current collector. Examples of the electro-conductive agent include acetylene black, carbon black, graphite, carbon fibers, graphene, carbon nanotubes, carbon nanofibers, and fullerenes. One of these may be used as the electro-conductive agent, or alternatively, two or more may be used in combination as the electro-conductive agent. The electro-conductive agent may be omitted.

The binder is blended to bind the positive electrode active material with the electro-conductive agent. Examples of the binder include polytetrafluoroethylene (PTFE), polyvinylidene fluoride (PVdF), fluorine-based rubbers, polyacrylonitrile, and polyethylene oxide. One of these may be used as the binder, or alternatively, two or more may be used in combination as the electro-conductive agent.

The proportions of the positive electrode active material, electro-conductive agent, and binder included in the positive electrode active material-containing layer are preferably adjusted respectively to 80% by mass or more and 95% by mass or less, 3% by mass or more and 18% by mass or less, and 2% by mass or more and 17% by weight or less. By having the amount of the electro-conductive agent adjusted to 3% by mass or more, the above-mentioned effects can be achieved. By having the amount of the electro-conductive agent adjusted to 18% by mass or less, decomposition of the electrolyte at the surface of the electro-conductive agent under high-temperature storage can be reduced. The by having the amount of the binder adjusted to 2% by mass or more, sufficient positive electrode strength can be provided. By having the amount of the binder adjusted to 17% by mass or less, the amount of the binder, which is an insulating material, blended in the positive electrode can be reduced, whereby the internal resistance can be reduced.

The positive electrode current collector is preferably an aluminum foil or an aluminum alloy foil containing one or more elements selected from Mg, Ti, Zn, Ni, Cr, Mn, Fe, Cu, and Si.

The thickness of the aluminum foil or aluminum alloy foil is preferably within a range from 5 μm to 20 μm, and is more preferably 15 μm or less. The purity of the aluminum foil is preferably 99% by mass or more. The content of transition metals such as iron, copper, nickel, and chromium contained in the aluminum foil or aluminum alloy foil is preferably 1% by mass or less.

In addition, the positive electrode current collector may include a portion where the surface thereof has no positive electrode active material-containing layer formed thereon. This portion can serve as a current collecting tab.

The positive electrode may be prepared, for example, by the following method. First, the positive electrode active material, electro-conductive agent, and binder are suspended in a solvent to prepare a slurry. This slurry is applied onto one side or both sides of the positive electrode current collector. Next, the applied slurry is dried to obtain a stack of the positive electrode active material-containing layer and the current collector. Thereafter, the stack is pressed. The positive electrode is thus prepared.

Alternatively, the positive electrode may be prepared by the following method. First, the positive electrode active material, electro-conductive agent, and binder are mixed to obtain a mixture. The mixture is then formed into pellets. The positive electrode can be obtained by subsequently arranging these pellets on the positive electrode current collector.

(2) Negative Electrode

The negative electrode includes a titanium-containing oxide as a negative electrode active material. Examples of the titanium-containing oxide include niobium-titanium composite oxides. The negative electrode may include a negative electrode active material-containing layer containing a negative electrode active material. The negative electrode may further include a negative electrode current collector.

The negative electrode active material-containing layer may be formed on one face or both the front and reverse faces of the negative electrode current collector. The negative electrode active material-containing layer may optionally contain an electro-conductive agent and a binder, in addition to the negative electrode active material.

The crystal structure of the niobium-titanium composite oxide may be, for example, monoclinic. When the negative electrode active material includes a monoclinic niobium-titanium composite oxide, high rate performance can be achieved in addition to an excellent energy density. The reason for this will be described by taking Nb₂TiO₇, which is a kind of monoclinic niobium-titanium composite oxide, as an example. The crystal structure of Nb₂TiO₇ has a large equivalent insertion space for lithium ions and is structurally stable.

Furthermore, there are regions having a two-dimensional channel in which lithium ions diffuse rapidly and a conductive path in a [001] direction, connecting between the regions. As a result, in the crystal structure of the monoclinic niobium-titanium composite oxide Nb₂TiO₇, insertion/extraction property of the lithium ions into the insertion space is improved and an insertion/extraction space of the lithium ions is effectively increased. As a result, it is possible to provide high capacity and high rate performance.

An example of monoclinic niobium-titanium composite oxide includes a composite oxide represented by LiₐTi_{1-b}M1_{b}Nb_{2-c}M2_{c}O_{7+δ}. Here, M1 is at least one selected from the group consisting of Zr, Si, and Sn. M2 is at least one selected from the group consisting of V, Ta, and Bi. Each subscript in the composition formula are 0≤a≤5, 0≤b<1, 0≤c<2, and −0.3≤δ≤0.3. A specific example of the monoclinic niobium-titanium composite oxide is LiₐNb₂TiO₇ (0≤a≤5).

Another example of the monoclinic niobium-titanium composite oxide is a composite oxide represented by LiₐTi_{1-b}M3_{b+c}Nb_{2-c}O_{7-δ}. Here, M3 is at least one selected from the group consisting of Mg, Fe, Ni, Co, W, Ta, and Mo. Each subscript in the composition formula are 0≤a≤5, 0≤b<1, 0≤c<2, and −0.3≤δ≤0.3.

Specific examples of the niobium-titanium composite oxides include Nb₂TiO₇, Nb₂Ti₂O₉, Nb₁₀Ti₂O₂₉, Nb₁₄TiO₃₇, and Nb₂₄TiO₆₂. The niobium-titanium composite oxide may be a substituted niobium-titanium composite oxide in which at least a part of Nb and/or Ti is substituted with a dopant. Examples of substitution elements are Na, K, Ca, Co, Ni, Si, P, V, Cr, Mo, Ta, Zr, Mn, Fe, Mg, B, Pb, and Al. The substituted niobium-titanium composite oxide may include one species or two or more species of the substitution elements.

In the niobium-titanium composite oxide, the elemental ratio between niobium and the other elements may deviate from the theoretical value with respect to the above-described general formula or composition formula. For example, the amount of niobium is preferably larger in comparison between the theoretical values of niobium and other elements. Thereby, niobium ions elute out from the negative electrode into the electrolyte during initial charge when adjusting the negative electrode potential, whereby uniform formation of a sulfur-containing coating on the negative electrode surface is promoted. Thus, there tends to be obtained a negative electrode with excellent high-temperature resistance.

Other examples of titanium-containing oxides (titanium-containing oxides other than niobium-titanium composite oxide) include lithium titanate having a ramsdellite structure (for example, Li_{2+d}Ti₃O₇, 0≤d≤3), lithium titanate having a spinel structure (for example, Li_{4+d}Ti₅O₁₂, 0≤d≤3), titanium dioxide (TiO₂), anatase titanium dioxide, rutile titanium dioxide, niobium pentoxide (Nb₂O₅), hollandite titanium composite oxide, and orthorhombic titanium composite oxides.

Examples of the orthorhombic titanium composite oxide include a compound represented by Li₂₊ₑM4_{2-f}Ti_{6-g}M5ₕO_{14+σ}. Here, M4 is at least one selected from the group consisting of Sr, Ba, Ca, Mg, Na, Cs, Rb, and K. M5 is at least one selected from the group consisting of Zr, Sn, V, Nb, Ta, Mo, W, Y, Fe, Co, Cr, Mn, Ni and Al. The respective subscripts in the composition formula are 0≤e≤6, 0≤f<2, 0≤g<6, 0≤h<6, and −0.5≤σ≤0.5. Specific examples of the orthorhombic titanium-containing composite oxide include Li₂₊ₑNa₂Ti₆O₁₄ (0≤e≤6).

Of the above orthorhombic titanium composite oxides, a compound with M5 including at least Nb corresponds to an example of the niobium-titanium composite oxide. A specific example of such a titanium-niobium composite oxide of orthorhombic crystal structure is a compound represented by Li₊ₘNa₂₋ₙM6ₚTi_{6-q-r}Nb_{q}M7ᵣO_{14+σ}. In general formula Li₂₊ₘNa₋ₘM6ₚTi_{6-q-r}Nb_{q}M7ᵣO_{14+σ}, subscript m is within a range of 0≤m≤4, subscript n is within a range of 0<n<2, subscript p is within a range of 0≤p<2, subscript q is within a range of 0<q<6, subscript r is within a range of 0≤r<3, a sum of the subscript q and the subscript r is within a range of 0<q+r<6, and subscript σ is within a range of −0.5≤σ≤0.5. Element M6 is at least one selected from the group consisting of Cs, K, Sr, Ba and Ca. Element M7 is at least one selected from the group consisting of Zr, Sn, V, Ta, Mo, W, Fe, Mn and Al.

The negative electrode active material may singly include one of the above titanium-containing oxides, or may include a combination of two or more.

The negative electrode active material preferably includes a niobium-titanium composite oxide. For example, the niobium-titanium composite oxide is taken as a first titanium-containing oxide, and another titanium-containing oxide as negative electrode active material is taken as a second titanium-containing oxide. The negative electrode active material may include one or more of first titanium-containing oxides and one second titanium-containing oxide in combination, or may include one or more of first titanium-containing oxides and two or more of second titanium-containing oxides in combination. The negative electrode active material more preferably includes the first titanium-containing oxide (niobium-titanium composite oxide) in a proportion of, for example, 70% by mass or more, and still more preferably 90% by mass or more. The negative electrode active material may also include one or more of only first titanium-containing oxides (niobium-titanium composite oxides).

Alternatively, the negative electrode active material may also include one or more of only second titanium-containing oxides (titanium-containing oxides other than the niobium-titanium composite oxide). Of the second titanium-containing oxides, the negative electrode active material preferably includes lithium titanate having a spinel structure, represented by Li_{4+d}Ti₅O₁₂ wherein 0≤d≤3.

The negative electrode active material may further include other materials in addition to the titanium-containing oxide. Examples of other materials as the negative electrode active material include oxides of metals other than titanium such as Nb₂O₅, metal sulfides, and Li alloy materials. The negative electrode active material includes the titanium-containing oxide (the first titanium-containing oxide and/or the second titanium-containing oxide) in a proportion of, for example, 70% by mass or more, preferably 90% by mass or more.

The negative electrode active material is contained in the negative electrode active material-containing layer, for example, in the form of particles. The negative electrode active material particles may take the form of for example, primary particles, or may take the form of agglomerated secondary particles. The negative electrode active material particles may be a mixture of primary particles and secondary particles.

The average particle diameter (D₅₀) of the negative electrode active material particles falls within, for example, the range of 0.1 μm to 50 μm. The average particle size may be changed depending on the required battery performance. For example, the average particle size is preferably adjusted to 1.0 μm or less in order to enhance the rapid charge-and-discharge performance. Thereby, the diffusion distance of lithium ions within the crystal can be reduced, whereby the rapid charge/discharge performance can be enhanced. The average particle diameter can be determined by, for example, a laser diffraction method. The average particle diameter means, for example, a median diameter D₅₀ determined by a laser diffraction scattering method.

Whether the negative electrode active material particles include secondary particles or primary particles can be determined by observation with a scanning electron microscope (SEM: Scanning Electron Microscopy). Furthermore, the average primary particle diameter and average secondary particle diameter of the active material particles can be measured by SEM observation.

The BET (Brunauer, Emmett, Teller) specific surface area of the negative electrode active material is not particularly limited. The BET specific surface area is, however, preferably 1 m²/g or more and 20 m²/g or less, more preferably 2 m²/g or more and 10 m²/g or less.

When the specific surface area is 1 m²/g or more, the contact area with the electrolyte can be secured, whereby favorable discharge rate performance is likely to be obtained, and the charging time can be shortened. On the other hand, when the specific surface area is 20 m²/g or less, the reactivity with the electrolyte is not excessively increased, and the life performance can be improved. Furthermore, the coatability of slurry containing the negative electrode active material, for use in the electrode production described later, can be made favorable.

The average primary particle diameter of the negative electrode active material particles is not particularly limited, but is, for example, preferably 0.05 μm or more and 2 μm or less, more preferably 0.2 μm or more and 1 μm or less. The average secondary particle diameter of the negative electrode active material particles is not particularly limited, but is, for example, preferably 1 μm or more and 20 μm or less, more preferably 3 μm or more and 10 μm or less.

The electro-conductive agent is added to improve current collection performance and to suppress the contact resistance between the active material and the current collector. Examples of the electro-conductive agent include carbonaceous substances such as vapor grown carbon fiber (VGCF), carbon blacks such as acetylene black, graphite, carbon nanotubes, and carbon nanofibers. One of these may be used as the electro-conductive agent, or alternatively, two or more may be used in combination as the electro-conductive agent. Alternatively, instead of using an electro-conductive agent, a carbon coating or an electro-conductive inorganic material coating may be applied to the surface of the active material particle. Moreover, the current collecting performance of the active material-containing layer can be enhanced by coating carbon or an electro-conductive material on the active material surface while using an electro-conductive agent.

The binder is added to fill gaps among the dispersed active material and also to bind the negative electrode active material with the negative electrode current collector. Examples of the binder include polytetrafluoroethylene (PTFE), polyvinylidene fluoride (PVdF), fluorine rubber, styrene-butadiene rubber, polyacrylate compounds, imide compounds, carboxymethyl cellulose (CMC), and salts of CMC. One of these may be used as the binder, or alternatively, two or more may be used in combination as the binder.

In the negative electrode active material-containing layer, the negative electrode active material, electro-conductive agent, and binder are preferably included in proportions, respectively of 70% by mass or more and 96% by mass or less, 2% by mass or more and 28% by mass or less, and 2% by mass or more and 28% by mass or less. By having the amount of the electro-conductive agent adjusted to 2% by mass or more, the current collecting performance of the negative electrode active material-containing layer can be improved, and the large current performance of the secondary battery can be improved. Furthermore, by having the amount of the binder adjusted to 2% by mass or more, the binding property between the negative electrode active material-containing layer and the current collector can be enhanced, thereby improving cycle performance. On the other hand, each of the electro-conductive agent and the binder are preferably included at 28% by mass or less, in view of achieving high capacity.

The density of the negative electrode active material-containing layer (excluding the current collector) is preferably 1.8 g/cm³ or more and 3.0 g/cm³ or less. The negative electrode in which the density of the negative electrode active material-containing layer falls within this range is excellent in energy density and electrolyte retention. The density of the negative electrode active material-containing layer is more preferably 2.1 g/cm³ or more and 2.8 g/cm³ or less.

Used for the negative electrode current collector is a material that is electrochemically stable at an electric potential at which lithium (Li) is inserted into and extracted from the negative electrode active material. The negative electrode current collector is preferably made from, for example, copper, nickel, stainless steel or aluminum, or an aluminum alloy containing one or more elements selected from Mg, Ti, Zn, Mn, Fe, Cu, and Si. The thickness of the negative electrode current collector is preferably 5 μm or more and 20 μm or less. The negative electrode current collector with such a thickness can be balanced between the strength and reduction in weight for the negative electrode.

In addition, the negative electrode current collector may include a portion where the surface thereof has no negative electrode active material-containing layer formed thereon. This portion can serve as a current collecting tab.

The negative electrode may be fabricated, for example, by the following method. First, the negative electrode active material, electro-conductive agent, and binder are suspended in a solvent to prepare a slurry. This slurry is applied onto one or both sides of the negative electrode current collector. Then, the applied slurry is dried to obtain a stack of the negative electrode active material-containing layer and the current collector. Thereafter, this stack is subjected to pressing. In this way, the negative electrode can be fabricated.

Alternatively, the negative electrode may be fabricated by the following method. First, the negative active material particles, electro-conductive agent, and binder are mixed to obtain a mixture. The mixture is then formed into pellets. The negative electrode can be obtained by subsequently arranging these pellets on the negative electrode current collector.

(3) Electrolyte

As the electrolyte, for example, a liquid nonaqueous electrolyte or gel nonaqueous electrolyte may be used. The liquid nonaqueous electrolyte is prepared by dissolving an electrolyte salt as solute in an organic solvent. The concentration of electrolyte salt is preferably from 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂), and mixtures thereof. The electrolyte salt is preferably resistant to oxidation even at a high potential, and most preferably LiPF₆.

Examples of the organic solvent include cyclic carbonates such as propylene carbonate (PC), ethylene carbonate (EC), or vinylene carbonate (VC); linear carbonates such as diethyl carbonate (DEC), dimethyl carbonate (DMC), or methyl ethyl carbonate (MEC); cyclic ethers such as tetrahydrofuran (THF), 2-methyl tetrahydrofuran (2-MeTHF), or dioxolane (DOX); linear ethers such as dimethoxy ethane (DME) or diethoxy ethane (DEE); γ-butyrolactone (GBL), acetonitrile (AN), and sulfolane (SL). These organic solvents may be used singularly or as a mixed solvent.

The electrolyte includes a sulfur-containing compound. The electrolyte may contain niobium ions, or may include no niobium ions. The electrolyte includes one or more sulfur-containing compound selected, for example, from sultone compounds and imide compounds containing a sulfur atom.

The concentration of the sulfur-containing compound in the electrolyte is preferably 0.1% by mass to 3% by mass, more preferably 0.5% by mass to 1.5% by mass, with respect to the electrolyte. In the secondary battery produced by an aspect in which the concentration falls within the preferred range, the effect of suppressing gas generation can be exhibited while suppressing an increase in negative electrode resistance due to further production of excessive film.

The sultone compound includes at least one selected from the group consisting of 1,3-propane sultone, 1,3-propene sultone, 1,4-butane sultone, and 2,4-butane sultone. The imide compound containing a sulfur atom includes, for example, at least one selected from lithium bis(trifluoromethanesulfonyl)imide (LiTFSI) or lithium bis(fluorosulfonyl)imide (LiFSI). The sulfur-containing compound may include one selected from the group consisting of these compounds, or may include two or more in mixture.

In a case where the sulfur-containing film formed at the negative electrode active material-containing layer contains the S element derived from the imide compound, there is a tendency for the film to be formed thinner in compared with a case of containing the S-element derived from the sultone compound. Thus, in the case where the film containing the S element derived from the imide compound is formed, the resistance value can be further lowered, which is preferred. Therefore, in the case where the electrolyte includes the imide compound, there can be realized a secondary battery with lower resistance as compared with the case where the electrolyte includes the sultone compound.

The preferred niobium ion concentration in the electrolyte is 0.01 mg/L to 300 mg/L, more preferably 1 mg/L to 100 mg/L. The niobium ion concentration within the electrolyte can be examine by high frequency inductively coupled plasmas (ICP) analysis.

The forms of niobium ions within the electrolyte include, for example, Nb⁵⁺, Nb⁴⁺ and Nb³⁺. The niobium ions contained in the electrolyte may be derived from, for example, a salt such as NbCl₅. In other words, a salt such as NbCl₅ may be dissolved in the electrolyte. If the niobium ion concentration in the electrolyte is adequately high upon holding the battery architecture in the potential adjusted state, film formation is promoted. If the niobium ion concentration is kept to a certain level or lower, charge-and-discharge is not inhibited by niobium ions, whereby long battery life can be expected.

The gel nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Alternatively, other than the liquid nonaqueous electrolyte and gel nonaqueous electrolyte, a room temperature molten salt (ionic melt) including lithium ions, a polymer solid electrolyte, an inorganic solid electrolyte, or the like may be used as the nonaqueous electrolyte.

The room temperature molten salt (ionic melt) indicates compounds among organic salts made of combinations of organic cations and anions, which are able to exist in a liquid state at room temperature (15° C. to 25° C.). The room temperature molten salt includes a room temperature molten salt which exists alone as a liquid, a room temperature molten salt which becomes a liquid upon mixing with an electrolyte salt, a room temperature molten salt which becomes a liquid when dissolved in an organic solvent, and mixtures thereof. In general, the melting point of the room temperature molten salt used in secondary batteries is 25° C. or below. The organic cations generally have a quaternary ammonium framework.

The polymer solid electrolyte is prepared by dissolving the electrolyte salt in a polymeric material, and solidifying it.

The inorganic solid electrolyte is a solid substance having Li ion conductivity.

(4) Separator

The separator may be made of, for example, a porous film or synthetic resin nonwoven fabric including polyethylene (PE), polypropylene (PP), cellulose, or polyvinylidene fluoride (PVdF). In view of safety, a porous film made of polyethylene or polypropylene is preferred. This is because such a porous film melts at a fixed temperature and thus able to shut off current.

(5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal container is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), prismatic, cylinder, coin, or button-shaped. The container member may be appropriately selected depending on battery size and use of the battery.

(6) Negative Electrode Terminal

The negative electrode terminal may be made of a material that is electrochemically stable at the potential at which Li is inserted into and extracted from the titanium-containing oxide, and has electrical conductivity. Specific examples of the material for the negative electrode terminal include copper, nickel, stainless steel, aluminum, and aluminum alloy containing at least one selected from the group consisting of Mg, Ti, Zn, Mn, Fe, Cu, and Si. Aluminum or aluminum alloy is preferred as the material for the negative electrode terminal.

The negative electrode terminal is preferably made of the same material as the negative electrode current collector, in order to reduce the contact resistance between the negative electrode terminal and the negative electrode current collector.

(7) Positive Electrode Terminal

The positive electrode terminal may be made of, for example, a material that is electrically stable in the potential range of 3 V to 4.5 V (vs. Li/Li⁺) relative to the redox potential of lithium, and has electrical conductivity. Examples of the material for the positive electrode terminal include aluminum and an aluminum alloy containing one or more selected from the group consisting of Mg, Ti, Zn, Mn, Fe, Cu, and Si. The positive electrode terminal is preferably made of the same material as the positive electrode current collector, in order to reduce contact resistance between the positive electrode terminal and the positive electrode current collector.

<Powder X-Ray Diffraction>

The crystal structure of the compound included as active material can be examined by X-ray diffraction (XRD). For example, the crystal structures of the titanium-containing oxide and other compounds included in the negative electrode active material, and the crystal structures of the nickel-containing composite oxide and other compounds included in the positive electrode active material can be examined by powder X-ray diffraction measurements. As an apparatus for powder X-ray diffraction measurement, for example, SmartLab manufactured by Rigaku or an apparatus having equivalent functions is used. Measurement is performed under the following conditions:

X-ray source: Cu target

Output: 45 kV, 200 mA

soller slit: 5 degrees in both incident light and received light

step width (2θ): 0.02 deg

scan speed: 20 deg/min

semiconductor detector: D/teX Ultra 250

sample plate holder: flat glass sample plate holder (0.5 mm thick)

measurement range: 5°≤2θ≤90°

Next, the battery architecture used in the production method fora secondary battery according to the embodiment will be more specifically described with reference to the drawings.

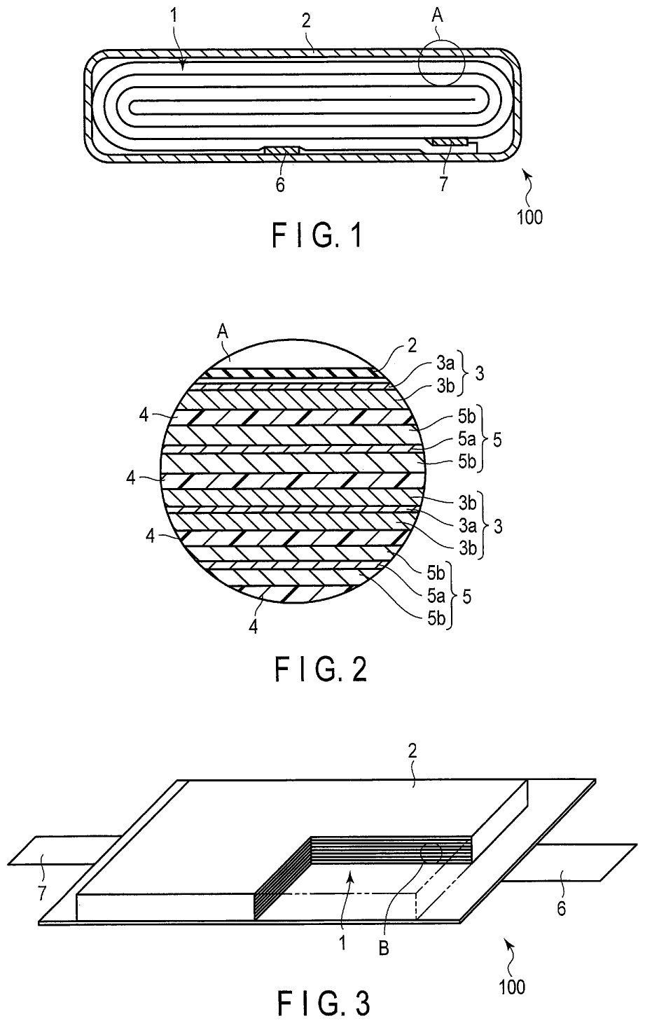

FIG. 1 is a cross-sectional view schematically showing an example of a battery architecture according to the embodiment. FIG. 2 is an enlarged cross-sectional view of section A of the battery architecture shown in FIG. 1.

The battery architecture 100 shown in FIGS. 1 and 2 includes a bag-shaped container member 2 shown in FIG. 1, an electrode group 1 shown in FIGS. 1 and 2, and an electrolyte, which is not shown. The electrode group 1 and the electrolyte are housed in the bag-shaped container member 2. The electrolyte (not shown) is held in the electrode group 1.

The bag-shaped container member 2 is made of a laminate film including two resin layers and a metal layer sandwiched between the resin layers.

As shown in FIG. 1, the electrode group 1 is a wound electrode group in a flat form. The wound electrode group 1 in a flat form includes a negative electrode 3, a separator 4, and a positive electrode 5, as shown in FIG. 2. The separator 4 is sandwiched between the negative electrode 3 and the positive electrode 5.

The negative electrode 3 includes a negative electrode current collector 3a and a negative electrode active material-containing layer 3b. At the portion of the negative electrode 3 positioned outermost among the wound electrode group 1, the negative electrode active material-containing layer 3b is formed only on an inner surface of the negative electrode current collector 3a, as shown in FIG. 2. For the other portions of the negative electrode 3, negative electrode active material-containing layers 3b are formed on both of reverse surfaces of the negative electrode current collector 3a.

The positive electrode 5 includes a positive electrode current collector 5a and positive electrode active material-containing layers 5b formed on both of reverse surfaces of the positive electrode current collector 5a.

As shown in FIG. 1, a negative electrode terminal 6 and positive electrode terminal 7 are positioned in vicinity of the outer peripheral edge of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend out from an opening of the bag-shaped container member 2.

A thermoplastic resin layer is provided on the inner surface of a bag-shaped container member 2, and is thermally fused to close the opening of the bag-shaped container member 2. For either of the temporary sealing before the treatment of holding the battery architecture 100 in the state where the electrode potential is adjusted, and the full sealing after the treatment and degassing, the opening of the bag-shaped container member 2 is closed, for example, by thermal fusion. The position where thermal fusion is performed during temporary sealing is, for example, a position closer to the opening end portion than the position where thermal fusion is performed in the full sealing.

A liquid electrolyte may be injected, for example, from the opening of the bag-shaped container member 2 before temporary sealing. For example, the opening of the bag-shaped container member 2 is closed by thermal fusion with a part left, and the liquid electrolyte is injected through the part left without thermal fusion. Then, the portion into which the electrolyte is injected is closed by thermal fusion and temporarily sealed.

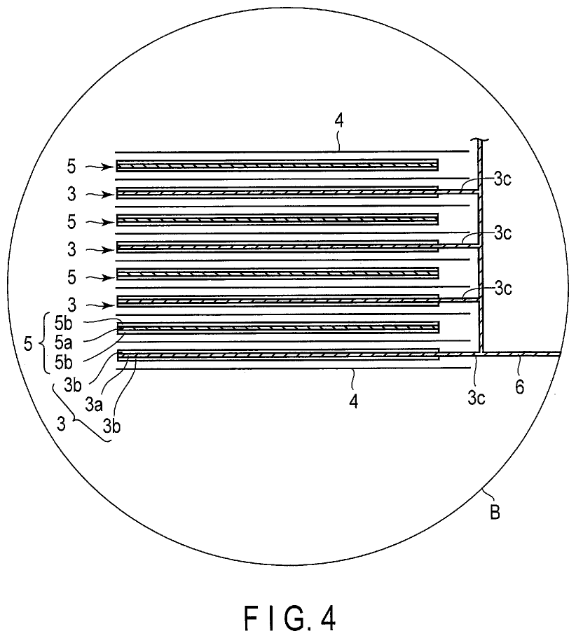

The battery architecture according to the embodiment is not limited to the battery architecture of the configuration shown in FIGS. 1 and 2, and may be, for example, a battery of a structure as shown in FIGS. 3 and 4.

FIG. 3 is a partially cut-out perspective view schematically showing another example of a battery architecture according to the embodiment. FIG. 4 is an enlarged cross-sectional view of section B of the battery architecture shown in FIG. 3.

The battery architecture 100 shown in FIGS. 3 and 4 includes an electrode group 1 shown in FIGS. 3 and 4, a container member 2 shown in FIG. 3, and an electrolyte, which is not shown. The electrode group 1 and the electrolyte are housed in the container member 2. The electrolyte is held in the electrode group 1.

The container member 2 is made of a laminate film including two resin layers and a metal layer sandwiched between the resin layers.

As shown in FIG. 4, the electrode group 1 is a stacked electrode group. The stacked electrode group 1 has a structure in which negative electrodes 3 and positive electrodes 5 are alternately stacked with separator(s) 4 sandwiched therebetween.

The electrode group 1 includes plural negative electrodes 3. Each of the negative electrodes 3 includes the negative electrode current collector 3a and the negative electrode active material-containing layers 3b supported on both surfaces of the negative electrode current collector 3a. The electrode group 1 further includes plural positive electrodes 5. Each of the positive electrodes 5 includes the positive electrode current collector 5a and the positive electrode active material-containing layers Sb supported on both surfaces of the positive electrode current collector 5a.

The negative electrode current collector 3a of each of the negative electrodes 3 includes at one end, a portion 3c where the negative electrode active material-containing layer 3b is not supported on either surface. This portion 3c serves as a negative electrode tab. As shown in FIG. 4, the portions 3c serving as the negative electrode tabs do not overlap the positive electrodes 5. The plural negative electrode tabs (portions 3c) are electrically connected to the strip-shaped negative electrode terminal 6. A tip of the strip-shaped negative electrode terminal 6 is drawn to the outside from the container member 2.

Although not shown, the positive electrode current collector 5a of each of the positive electrodes 5 includes at one end, a portion where the positive electrode active material-containing layer 5b is not supported on either surface. This portion serves as a positive electrode tab. Like the negative electrode tabs (portion 3c), the positive electrode tabs do not overlap the negative electrodes 3. Further, the positive electrode tabs are located on the opposite side of the electrode group 1 with respect to the negative electrode tabs (portion 3c). The positive electrode tabs are electrically connected to the strip-shaped positive electrode terminal 7. A tip of the strip-shaped positive electrode terminal 7 is located on the opposite side relative to the negative electrode terminal 6 and drawn to the outside from the container member 2.

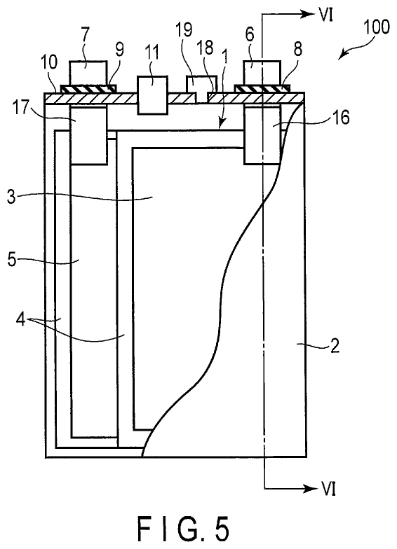

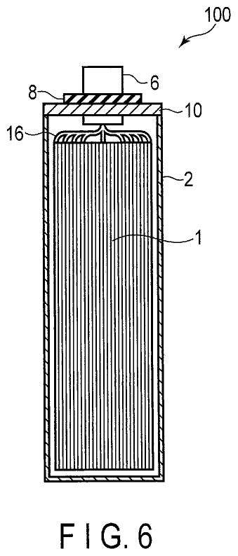

Yet another example of the battery architecture is explained with reference to FIGS. 5 and 6. FIG. 5 is a cross-sectional view schematically illustrating yet another example of the battery architecture according to the embodiment. FIG. 6 is a schematic cross-sectional view along a line VI-VI of shown in FIG. 5 of the battery architecture.

An electrode group 1 is housed in a container member 2 made of a rectangular tubular metal container. The electrode group 1 includes a negative electrode 3, a separator 4, and a positive electrode 5. The electrode group 1 has a structure formed by interposing the separator 4 between the positive electrode 5 and the negative electrode 3, and spirally winding so as to form a flat shape. An electrolyte (not shown) is held in the electrode group 1. As shown in FIG. 5, a strip-shaped negative electrode lead 16 is electrically connected to each of plural portions at an end of the negative electrode 3 located on an end face of the electrode group 1. In addition, a strip-shaped positive electrode lead 17 is electrically connected to each of plural portions at an end of the positive electrode 5 located on the end face. The plural negative electrode leads 16 are electrically connected to a negative electrode terminal 6 in a bundled state, as shown in FIG. 6. In addition, the plural positive electrode leads 17 are similarly electrically connected to a positive electrode terminal 7 in a bundled state, although not shown.

A sealing plate 10 made of metal is fixed to the opening portion of the container member 2 made of metal by welding or the like. The negative electrode terminal 6 and the positive electrode terminal 7 are extracted to the outside from outlets provided on the sealing plate 10, respectively. On the inner surfaces of each outlet of the sealing plate 10, a negative electrode gasket 8 and a positive electrode gasket 9 are arranged to avoid a short circuit caused by contact respective with the negative electrode terminal 6 and the positive electrode terminal 7. By providing the negative electrode gasket 8 and the positive electrode gasket 9, the airtightness of the secondary battery can be maintained.

A control valve 11 (safety valve) is provided on the sealing plate 10. When the internal pressure of the battery cell is raised by gas generated within the secondary battery, the generated gas can be released from the control valve 11 to the outside. In FIG. 5, the control valve 11 is disposed at the center of the sealing plate 10. However, the position of the control valve 11 may be an end of the sealing plate 10. The control valve 11 may be omitted.

Additionally, an inlet 18 is provided on the sealing plate 10. The electrolyte may be put in via the inlet 18. The inlet 18 may be closed with a sealing plug 19 after the electrolyte is put in. The inlet 18 and the sealing plug 19 may be omitted. When implementing the temporary sealing before performing the treatment of holding the battery architecture 100 in the state with the electrode potentials adjusted, for example, a sealing plug 19 made of rubber may be used. When implementing the full sealing after the treatment and degassing, for example, a sealing plug 19 made of the same material as the sealing plate 10 is used and welded onto the sealing plate 10 in a state with the inlet 18 closed.

The production method for a secondary battery according to a first embodiment includes holding a battery architecture that includes a positive electrode, a negative electrode, and an electrolyte in a potential adjusted state where a positive electrode potential is adjusted to be within a range of 4.3 V to 4.8 V relative to the oxidation-reduction potential of lithium, while the negative electrode potential is adjusted to be within a range of 0.5 V to 1.1 V relative to the oxidation-reduction potential of lithium. The positive electrode includes a nickel-containing oxide represented by a general formula LiₓM1O₂. Here, M1 is a metal element including at least Ni in an elemental ratio of 50% or more, and 0<x≤1. The negative electrode includes a titanium-containing oxide. The electrolyte includes a sulfur-containing compound. While gas generation is suppressed low in the production method, the production method can produce a secondary battery with excellent life performance under high temperature environments.

### Second Embodiment

According to a second embodiment, a secondary battery is provided. The secondary battery is a secondary battery produced by the production method according to the first embodiment.

That is, the secondary battery according to the second embodiment is a secondary battery obtained by holding the battery architecture in a state where the above-described electrode potential adjustment is performed for the battery architecture in the production method according to the first embodiment. Therefore, the secondary battery may be, for example, a nonaqueous electrolyte secondary battery or a lithium ion nonaqueous electrolyte secondary battery.

As compared with the battery architecture as a secondary battery precursor before the electrode potential adjustment as described in the first embodiment, the details of the secondary battery according to the second embodiment are the same as those of the battery architecture described in the first embodiment, except that the secondary battery is in a state of a finished product after pre-treatment and accompanying degassing and full sealing. That is, the secondary battery according to the second embodiment includes the positive electrode, the negative electrode, and the electrolyte described in the first embodiment. In addition, the secondary battery according to the second embodiment may include the separator, the container member, the positive electrode terminal, and the negative electrode terminal described in the first embodiment. Since details overlap, description thereof is omitted.

However, the battery architecture before the posttreatment has no film on the electrode surface, and in the secondary battery, the positive and negative electrodes have a film on the surface. In addition, the battery architecture before the posttreatment may be in a temporarily sealed state, and the secondary battery is in a fully sealed state.

The secondary battery according to the second embodiment is produced by the method of producing a secondary battery according to the first embodiment. Therefore, such a secondary battery can exhibit high output performance, and gas generation is small although a charge-and-discharge cycle is repeated.

The secondary battery according to the second embodiment is produced by the method of producing a secondary battery according to the first embodiment. Therefore, the secondary battery is excellent in life performance in a high-temperature environment.

### EXAMPLES

Examples will be described below; however, the embodiments are not limited to the examples described below.

### Example 1

A secondary battery was produced by the following procedure.

<Fabrication of Positive Electrode>

A lithium nickel composite oxide LiNi_{0.8}Co_{0.1}Mn_{0.1}O₂ powder was prepared as a positive electrode active material.

Acetylene black was prepared as an electro-conductive agent. Polyvinylidene fluoride (PVdF) was prepared as a binder. Then, the positive electrode active material, the electro-conductive agent, and the binder were added and mixed at proportions of 90 parts by mass:10 parts by mass:10 parts by mass into N-methylpyrrolidone (NMP) to prepare a positive electrode slurry. This positive electrode slurry was applied onto both surfaces of a current collector made of an aluminum foil having a thickness of 15 μm. Then, the coating film was dried in a thermostatic bath at 120° C. and pressed to provide a positive electrode.

<Fabrication of Negative Electrode>

A niobium-titanium composite oxide Nb₂TiO₇ powder was prepared as a negative electrode active material. The average secondary particle size of the niobium-titanium composite oxide was 7.5 μm. The specific surface area of the niobium-titanium composite oxide was 4.0 m²/g. In addition, acetylene black was prepared as an electro-conductive agent, and PVdF was prepared as a binder. Then, the negative electrode active material, the electro-conductive agent, and the binder were added and mixed at proportions of 90 parts by mass:10 parts by mass:10 parts by mass into NMP to prepare a negative electrode slurry. This negative electrode slurry was applied onto both surfaces of a current collector made of an aluminum foil having a thickness of 15 μm. Then, the coating film was dried in a thermostatic bath at 120° C. and pressed to provide a negative electrode.

<Fabrication of Electrode Group>

Two sheets of nonwoven fabrics made of polyethylene having a thickness of 25 μm were prepared as separators. Then, the positive electrode, a separator, the negative electrode, and a separator were stacked in this order to provide a stack. Then, this stack was spirally wound. This was hot-pressed at 80° C. to produce a flat electrode group.

<Housing the Electrode Group>

Then, there was prepared a container including a laminate film having a three-layer structure of nylon layer/aluminum layer/polyethylene layer and having a thickness of 0.1 mm. The electrode group produced as described above was housed in this container. Then, the inside of the container was dried in vacuum at 80° C. for 16 hours with a part of the periphery of the container opened.

<Preparation of Liquid Nonaqueous Electrolyte>

LiPF₆ as an electrolyte was dissolved in a mixed solvent of propylene carbonate (PC) and diethyl carbonate (DEC) (volume ratio of 1:2) at a concentration of 1 mol/L. Furthermore, 1,3-propane sultone (PS) as a sulfur-containing compound was dissolved so that the concentration in the nonaqueous electrolyte was 1% by mass. Thus, a liquid nonaqueous electrolyte was obtained. The preparation of the nonaqueous electrolyte was performed in an argon box.

<Fabrication of Battery Architecture>

The nonaqueous electrolyte was put into the container housing the electrode group. Then, the open portion of the periphery of the container was heat-sealed to seal the container. Thus, there was obtained a battery architecture having outer dimensions of 11 cm×8 cm×0.3 cm excluding the tabs and inner dimensions (dimensions of the sealed portion) of 9 cm×7 cm×0.25 cm.

<Initial Charge>

The battery architecture was subjected to initial charge in an environment of 25° C. according to the following procedure. First, the battery was charged at a constant current (CC) of 0.2 C until a voltage of 3 V was reached. Then, the battery was charged at a constant voltage (CV) of 3 V. The constant voltage charge was terminated when the total time of the constant current charge and the constant voltage charge reached 10 hours. In addition, in the constant voltage charge, conditions were adjusted so that the charge termination potential of the positive electrode in the initial charge was 4.2 V (vs. Li/Li⁺) and the charge termination potential of the negative electrode was 1.2 V (vs. Li/Li⁺). This state was defined as SOC 100%.

<Initial Discharge>

Then, the battery architecture was discharged at a constant current (CC) of 0.2 C under an environment of 25° C. until the voltage reached 1.5 V.

<Posttreatment>

Then, the battery architecture was charged at a constant current (CC) of 0.2 C under an environment of 25° C. until the voltage reached 3.3 V. Then, the battery was charged at a constant voltage (CV) of 3.3 V until the current value reached 1/20C. That is, the battery was subjected to constant-current constant-voltage (CCCV) charge. As a result, the SOC of the battery architecture was 120%. This battery architecture was placed in a thermostatic bath at 45° C. and held for 24 hours. Thereafter, the battery was placed in an argon box, degassed, and heat sealing was performed again.

Thus, the secondary battery according to Example 1 was produced.

### Examples 2 to 5

A secondary battery was produced in the same manner as in Example 1, except that the battery voltage during the posttreatment was changed to the voltage shown in Table 1 below.

### Comparative Example 1

A secondary battery was produced in the same manner as in Example 1, except that the battery voltage, temperature, and time during the posttreatment were changed to the voltage, temperature, and time shown in Table 1 below, respectively. In Comparative Example 1, the posttreatment time was zero, and therefore the posttreatment was regarded as having been omitted.

### Comparative Examples 2 to 4

A secondary battery was produced in the same manner as in Example 1, except that the battery voltage and temperature during the posttreatment were changed to the voltage and temperature shown in Table 1 below, respectively.

Table 1 summarizes the production conditions in Examples 1 to 5 and Comparative Examples 1 to 4. Specifics follow. The column of “sulfur-containing compound additive” indicates the compound species of the sulfur-containing compound added to the electrolyte. “PS” in this column means 1,3-propane sultone. The columns of “battery voltage”, “positive electrode potential”, and “negative electrode potential” indicate the battery voltage when adjusted to the potential adjusted state in the posttreatment, and the positive electrode potential and the negative electrode potential corresponding to this battery voltage, respectively. The columns of “aging temperature” and “aging time” indicate the temperature of the thermostatic bath and the holding time when the battery architecture is held in the potential adjusted state in the posttreatment, respectively.

TABLE 1

| | Sulfur- | | Positive | Negative | | |
|---|---|---|---|---|---|---|
| | containing | Battery | electrode | electrode | Aging | Aging |
| | compound | voltage | potential | potential | temperature | time |
| | additive | (V) | (vs. Li/Li⁺) | (vs. Li/Li⁺) | (° C.) | (H) |
| Example 1 | PS | 3.3 | 4.35 | 1.05 | 45 | 24 |
| Comparative | PS | 3 | 4.2 | 1.2 | 25 | 0 |
| Example 1 | | | | | | |
| Comparative | PS | 3 | 4.2 | 1.2 | 80 | 24 |
| Example 2 | | | | | | |
| Example 2 | PS | 3.2 | 4.3 | 1.1 | 45 | 24 |
| Example 3 | PS | 3.4 | 4.43 | 1.03 | 45 | 24 |
| Example 4 | PS | 3.5 | 4.5 | 1 | 45 | 24 |
| Example 5 | PS | 3.8 | 4.7 | 0.9 | 45 | 24 |
| Comparative | PS | 3 | 4.2 | 1.2 | 45 | 24 |
| Example 3 | | | | | | |
| Comparative | PS | 4.1 | 4.9 | 0.8 | 45 | 24 |
| Example 4 | | | | | | |

### Examples 6 to 8

In Examples 6 to 8, the amount of the negative electrode slurry applied onto the current collector in preparing the negative electrode was reduced to make the negative electrode thin. A secondary battery was produced in the same manner as in Example 1, except that the production conditions of the negative electrode were changed in such a manner and the battery voltage during posttreatment was changed to the voltage shown in Table 2 below. The design potential was changed by making the negative electrode thin, whereby the positive electrode potential and the negative electrode potential during posttreatment had values shown in Table 2.

Table 2 summarizes the production conditions in Examples 6 to 8. The content of each item is the same as that in Table 1.

TABLE 2

| | Sulfur- | | Positive | Negative | | |
|---|---|---|---|---|---|---|
| | containing | Battery | electrode | electrode | Aging | Aging |
| | compound | voltage | potential | potential | temperature | time |
| | additive | (V) | (vs. Li/Li⁺) | (vs. Li/Li⁺) | (° C.) | (H) |
| Example 6 | PS | 3.3 | 4.3 | 1 | 45 | 24 |
| Example 7 | PS | 3.6 | 4.4 | 0.8 | 45 | 24 |
| Example 8 | PS | 4 | 4.5 | 0.5 | 45 | 24 |

### Examples 9 to 12

A secondary battery was produced in the same manner as in Example 1, except that the battery voltage and temperature during the posttreatment were changed to the voltage and temperature shown in Table 3 below, respectively.

Table 3 summarizes the production conditions in Examples 9 to 12. The content of each item is the same as that in Table 1.

TABLE 3

| | Sulfur- | | Positive | Negative | | |
|---|---|---|---|---|---|---|
| | containing | Battery | electrode | electrode | Aging | Aging |
| | compound | voltage | potential | potential | temperature | time |
| | additive | (V) | (vs. Li/Li⁺) | (vs. Li/Li⁺) | (° C.) | (H) |
| Example 9 | PS | 3.2 | 4.3 | 1.1 | 60 | 24 |
| Example 10 | PS | 3.5 | 4.5 | 1 | 25 | 24 |
| Example 11 | PS | 3.5 | 4.5 | 1 | 35 | 24 |
| Example 12 | PS | 3.3 | 4.35 | 1.05 | 10 | 24 |

### Examples 13 to 15

A secondary battery was produced in the same manner as in Example 1, except that the time for the posttreatment was changed to the time shown in Table 4 below.

Table 4 summarizes the production conditions in Examples 13 to 15. The content of each item is the same as that in Table 1.

TABLE 4

| | Sulfur- | | Positive | Negative | | |
|---|---|---|---|---|---|---|
| | containing | Battery | electrode | electrode | Aging | Aging |
| | compound | voltage | potential | potential | temperature | time |
| | additive | (V) | (vs. Li/Li⁺) | (vs. Li/Li⁺) | (° C.) | (H) |
| Example 13 | PS | 3.3 | 4.35 | 1.05 | 45 | 72 |
| Example 14 | PS | 3.3 | 4.35 | 1.05 | 45 | 168 |
| Example 15 | PS | 3.3 | 4.35 | 1.05 | 45 | 6 |

### Examples 16 to 19

A secondary battery was produced in the same manner as in Example 1, except that the sulfur-containing compound added to the electrolyte was changed to lithium bis (fluorosulfonyl) imide (LiFSI), and the battery voltage during the posttreatment was changed to the voltage shown in Table 5 below.

### Comparative Example 5

A secondary battery was produced in the same manner as in Example 1, except that the sulfur-containing compound added to the electrolyte was changed to lithium bis (fluorosulfonyl) imide (LiFSI), and the battery voltage, temperature, and time during the posttreatment were changed to the voltage, temperature, and time shown in Table 5 below. In Comparative Example 5, the posttreatment time was zero, and therefore the posttreatment was regarded as having been omitted.

### Comparative Example 6

A secondary battery was produced in the same manner as in Example 1, except that the sulfur-containing compound added to the electrolyte was changed to lithium bis (fluorosulfonyl) imide (LiFSI), and the battery voltage during the posttreatment was changed to the voltage shown in Table 5 below.

Table 5 summarizes the production conditions in Examples 16 to 19 and Comparative Examples 5 to 6. The content of each item is the same as that in Table 1.

TABLE 5

| | Sulfur- | | Positive | Negative | | |
|---|---|---|---|---|---|---|
| | containing | Battery | electrode | electrode | Aging | Aging |
| | compound | voltage | potential | potential | temperature | time |
| | additive | (V) | (vs. Li/Li⁺) | (vs. Li/Li⁺) | (° C.) | (H) |
| Example 16 | LiFSI | 3.3 | 4.35 | 1.05 | 45 | 24 |
| Example 17 | LiFSI | 3.2 | 4.3 | 1.1 | 45 | 24 |
| Example 18 | LiFSI | 3.4 | 4.43 | 1.03 | 45 | 24 |
| Example 19 | LiFSI | 3.5 | 4.5 | 1 | 45 | 24 |
| Comparative | LiFSI | 3 | 4.2 | 1.2 | 25 | 0 |
| Example 5 | | | | | | |
| Comparative | LiFSI | 3 | 4.2 | 1.2 | 80 | 24 |
| Example 6 | | | | | | |

### Examples 20 to 21

A secondary battery was produced in the same manner as in Example 1, except that the sulfur-containing compound added to the electrolyte was changed to the additive shown in Table 6 below, and the battery voltage during the posttreatment was changed to the voltage shown in Table 6 below.

Table 6 summarizes the production conditions in Examples 20 to 21. The content of each item is the same as that in Table 1.

TABLE 6

| | Sulfur- | | Positive | Negative | | |
|---|---|---|---|---|---|---|
| | containing | Battery | electrode | electrode | Aging | Aging |
| | compound | voltage | potential | potential | temperature | time |
| | additive | (V) | (vs. Li/Li⁺) | (vs. Li/Li⁺) | (° C.) | (H) |
| Example 20 | 1,3-propene sultone | 3.3 | 4.35 | 1.05 | 45 | 24 |
| Example 21 | 1,4-butane sultone | 3.3 | 4.35 | 1.05 | 45 | 24 |

(Evaluation)

<Amount of Gas Generated During Production>

The amount of gas generated during production of each secondary battery in each of the Examples and Comparative Examples was measured as follows.

When carrying out the posttreatment, the battery volume before and after degassing was measured. Specifically, the volume before opening the container for degassing and the volume after heat-sealing again after degassing were measured, and the difference between the volume [ml] of the latter and the volume [ml] of the former was taken as the gas generation amount [ml] (“amount of gas generated during production”=[volume after degassing]−[volume before degassing]). The results are shown in Tables 7 to 9 below.

<Storage Test>

The secondary batteries produced as the Examples and Comparative Examples were subjected to a storage test as follows.

The battery was charged at a constant current (CC) of 0.2 C until a voltage of 3 V was reached. Then, the battery was charged at a constant voltage (CV) of 3 V until the current value reached 1/20C. That is, the battery was subjected to constant-current constant-voltage (CCCV) charge, and the SOC thereof was set to 100%. The battery in this charged state was placed in a thermostatic bath at 55° C. Every 10 days, the battery was taken out from the thermostatic bath at 55° C., cooled to 25° C., then subjected to CCCV charge at 3 V again, and placed in the thermostatic bath at 55° C. This procedure was repeated, and the battery stored in the thermostatic bath for a span of 60 days was cooled to 25° C., then the volume was measured, and the difference from the volume before the test was taken as the gas generation amount [ml] (“gas generation amount after 60 days”=[volume before storage test]−[volume after 60 day storage test]). The results are shown in Tables 7 to 9 below.

<Measurement of Direct Current Resistance>

Direct current (DC) resistance measurement was performed as follows for each of the secondary batteries produced as Examples and Comparative Examples, before and after the above storage test.

The battery was discharged at a constant current (CC) of 0.2 C until the voltage reached 1.5 V. Thereafter, the battery was charged at a constant current (CC) of 0.2 C until the voltage reached 2.25 V. Then, the battery was charged at a constant voltage (CV) of 2.25 V until the current value reached 1/20C, whereby the state of charge of the battery was set to SOC 50%. The battery adjusted to SOC 50% was discharged at a constant current (CC) of 1 C and 10 C for 200 ms, respectively, and then the DC resistance [mΩ] was determined from the difference between the voltage value and the current value.

The rate of increase in resistance [mΩ/mΩ] during the storage test was calculated by dividing the DC resistance [mΩ] measured after the 60 day storage test by the DC resistance [mΩ] measured before the storage test (“DC resistance increase rate after 60 days”=[DC resistance after 60 day storage test]/[DC resistance before storage test]). The results are shown in Tables 7 to 9 below.

Table 7 below summarizes the evaluation result of each of the secondary batteries produced in Examples 1 to 15 and Comparative Examples 1 to 4. Table 8 below summarizes the evaluation results of Examples 16 to 19 and Comparative Examples 5 to 6. Table 9 below summarizes the evaluation results of Examples 20 to 21. In Tables 7 to 9, the column of “amount of gas generated during production” indicates the measurement results of the amount of gas generated during the posttreatment. The column of “amount of gas generated after 60 days” indicates the amount of gas generated in accordance with the storage test. The column of “rate of increase in DC resistance after 60 days” indicates the rate of increase in DC resistance observed in the storage test. The “amount of gas generated after 60 days” and the “rate of increase in DC resistance after 60 days” indicating the results of the storage test are indices of life performance in a high-temperature environment.

TABLE 7

| | Gas generation | Gas generation | DC resistance |
|---|---|---|---|
| | amount during | amount after | increase rate |
| | production | 60 days | after 60 days |
| | (ml) | (ml) | (mΩ/mΩ) |
| Example 1 | 0.5 or less | 0.8 | 1.26 |
| Comparative | 0.5 or less | 2 | 1.6 |
| Example 1 | | | |
| Comparative | 4.5 | 0.8 | 1.26 |
| Example 2 | | | |
| Example 2 | 0.5 or less | 0.9 | 1.34 |
| Example 3 | 0.5 or less | 1 | 1.27 |
| Example 4 | 0.5 or less | 1 | 1.26 |
| Example 5 | 0.5 or less | 1 | 1.26 |
| Comparative | 0.5 or less | 1.2 | 1.4 |
| Example 3 | | | |
| Comparative | 3.8 | 1 | 1.3 |
| Example 4 | | | |
| Example 6 | 0.5 or less | 0.9 | 1.26 |
| Example 7 | 0.5 or less | 1 | 1.24 |
| Example 8 | 1.5 | 1 | 1.26 |
| Example 9 | 0.5 or less | 1 | 1.23 |
| Example 10 | 0.5 or less | 1 | 1.38 |
| Example 11 | 0.5 or less | 1 | 1.37 |
| Example 12 | 0.5 or less | 1.8 | 1.39 |
| Example 13 | 0.5 or less | 1 | 1.36 |
| Example 14 | 2.1 | 1 | 1.35 |
| Example 15 | 0.5 or less | 1.1 | 1.39 |

TABLE 8

| | Gas generation | Gas generation | DC resistance |
|---|---|---|---|
| | amount during | amount after | increase rate |
| | production | 60 days | after 60 days |
| | (ml) | (ml) | (mΩ/mΩ) |
| Example 16 | 0.5 or less | 3.8 | 1.56 |
| Example 17 | 0.5 or less | 4.7 | 1.55 |
| Example 18 | 0.5 or less | 4 | 1.56 |
| Example 19 | 0.5 or less | 3.8 | 1.56 |
| Comparative | 0.5 or less | 6 | 1.75 |
| Example 5 | | | |
| Comparative | 4.9 | 2.3 | 1.4 |
| Example 6 | | | |

TABLE 9

| | Gas generation | Gas generation | DC resistance |
|---|---|---|---|
| | amount during | amount after | increase rate |
| | production | 60 days | after 60 days |
| | (ml) | (ml) | (mΩ/mΩ) |
| Example 20 | 0.5 or less | 0.5 or less | 1.15 |
| Example 21 | 0.5 or less | 0.5 or less | 1.17 |

Table 7 shows the evaluation results of the batteries of Examples 1 to 15 and Comparative Examples 1 to 4, in which 1,3-propane sultone (PS) was added to the electrolyte as the sulfur-containing compound. As shown in Table 7, in Examples 1 to 15, the amount of gas generated was small in both the production and the storage test, and the rate of increase in resistance in the storage test was suppressed.

In Comparative Example 1, the amount of gas generated was large and the rate of increase in resistance was high in the storage test. In Comparative Example 1, there was omitted the posttreatment of adjusting the potentials of the positive and negative electrodes to the potential adjusted state and then holding.

In Comparative Example 2, the amount of gas generated during production was large. In Comparative Example 3, the rate of increase in resistance during the storage test was high. In Comparative Example 4, the amount of gas generated during production was large, and the initial battery capacity was low although not shown in Table 7. In Comparative Examples 2 to 4, the posttreatment was performed; however, at least one of the potentials of the positive and negative electrodes fell outside the positive electrode potential range of 4.3 V or more and 4.8 V or less (vs. Li/Li⁺) and the negative electrode potential range of 0.5 V or more and 1.1 V or less (vs. Li/Li⁺).

Comparing the result of Examples 1 to 15 with the result of Comparative Examples 1 to 4, it is found that it is possible to reduce the amount of gas generated during production and high-temperature storage and to suppress an increase in battery resistance during high-temperature storage by performing the treatment of holding in the potential adjusted state where the positive electrode potential is within a range of 4.3 V or more and 4.8 V or less (vs. Li/Li⁺) and the negative electrode potential is within a range of 0.5 V or more and 1.1 V or less, in the battery including a nickel-containing oxide LiₓM1O₂ (M1 is a metal element including at least Ni in an elemental ratio of 50% or more, 0<x≤1) in the positive electrode, a titanium-containing oxide in the negative electrode, and the sulfur-containing compound added to the electrolyte.

Table 8 shows the evaluation results of the batteries of Examples 16 to 19 and Comparative Examples 5 to 6, in which lithium bis (fluorosulfonyl) imide (LiFSI) was added to the electrolyte as the sulfur-containing compound. Comparing the results of Examples 16 to 19 shown in Table 8 with those of Comparative Examples 5 and 6, it is found that the treatment under the above conditions can reduce the amount of gas generated during production and high-temperature storage, and can suppress an increase in battery resistance during high-temperature storage, also in the case where the sulfur-containing compound was changed from PS to LiFSI, as well.

Table 9 shows the evaluation results of the batteries of Examples 20 and 21, in which 1,3-propene sultone and 1,4-butane sultone were each added to the electrolyte as the sulfur-containing compound. From the results shown in Table 9, it is found that even when the sulfur-containing compound is changed, the amount of gas generated during production and high-temperature storage can still be reduced, and an increase in battery resistance during high-temperature storage can still be suppressed.

Similarly, for a secondary battery produced by using lithium titanate Li₄Ti₅O₁₂ having a spinel structure instead of the niobium-titanium composite oxide Nb₂TiO₇ as a negative electrode active material, the amount of gas generated during production and high-temperature storage can be reduced, and an increase in battery resistance during high-temperature storage can be suppressed.

According to at least one embodiment and example described above, a method for producing a secondary battery is provided. The method includes a step of preparing a battery architecture including a positive electrode, a negative electrode, and an electrolyte; a step of providing a potential adjusted state by adjusting a positive electrode potential to be within 4.3 V (vs. Li/Li⁺) to 4.8 V (vs. Li/Li⁺) with respect to an oxidation-reduction potential of lithium as standard, while adjusting a negative electrode potential to be within 0.5 V (vs. Li/Li⁺) to 1.1 V (vs. Li/Li⁺) with respect to an oxidation-reduction potential of lithium as standard; and a step of holding the battery architecture in the potential adjusted state. The positive electrode includes a nickel-containing oxide represented by general formula LiₓM1O₂, and in the general formula, M1 is a metal element including at least Ni in an elemental ratio of 50% or more, and 0<x≤1. The negative electrode includes a titanium-containing oxide. The electrolyte includes a sulfur-containing compound. According to the above, there are provided a production method for which gas generation during production is little and for which a secondary battery excellent in life performance under a high-temperature environment can be produced, and a secondary battery produced by the production method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of producing a secondary battery, the method comprising:
preparing a battery architecture, the battery architecture comprising a positive electrode, a negative electrode, and an electrolyte, the positive electrode comprising a nickel-containing oxide represented by a general formula LiₓM1O₂, in which M1 is a metal element including at least Ni in an elemental ratio of 50% or more and 0<x≤1, the negative electrode comprising a titanium-containing oxide, the electrolyte comprising a sulfur-containing compound;
providing a potential adjusted state by adjusting a positive electrode potential of the positive electrode to a range of 4.3 V or more and 4.8 V or less based on oxidation-reduction potential of lithium, and adjusting a negative electrode potential of the negative electrode to a range of 0.5 V or more and 1.1 V or less based on oxidation-reduction potential of lithium; and
holding the battery architecture in the potential adjusted state.

2. The method of producing a secondary battery according to claim 1, wherein the battery architecture is held in the potential adjusted state for 3 hours or more and 72 hours or less.

3. The method of producing a secondary battery according to claim 1, wherein the battery architecture is held in the potential adjusted state at a temperature of 60° C. or less.

4. The method of producing a secondary battery according to claim 1, wherein the providing of the potential adjusted state comprises subjecting the battery architecture to a 0.2 C constant current charge at 25° C.

5. The method of producing a secondary battery according to claim 4, wherein the providing of the potential adjusted state further comprises, prior to the 0.2 C constant current charge:
charging the battery architecture at a constant current of 0.2 C to a battery voltage of 3 V at 25° C. then charging at a constant voltage of 3 V; and
discharging the battery architecture at a constant current of 0.2 C to a battery voltage of 1.5 V at 25° C., thereafter.

6. The method of producing a secondary battery according to claim 1, wherein the sulfur-containing compound comprises one or more selected from the group consisting of a sultone compound and an imide compound containing a sulfur atom.

7. The method of producing a secondary battery according to claim 6, wherein the sulfur-containing compound comprises at least the sultone compound, and the sultone compound comprises one or more selected from the group consisting of 1,3-propane sultone, 1,3-propene sultone, 1,4-butane sultone, and 2,4-butane sultone.

8. The method of producing a secondary battery according to claim 6, wherein the sulfur-containing compound comprises at least the imide compound, and the imide compound comprises one or more selected from the group consisting of lithium bis(trifluoromethanesulfonyl)imide and lithium bis(fluorosulfonyl)imide.

9. The method of producing a secondary battery according to claim 1, wherein a concentration of the sulfur-containing compound in the electrolyte is 0.1% by mass or more and 3% by mass or less with respect to the electrolyte.

10. The method of producing a secondary battery according to claim 1, wherein the titanium-containing oxide comprises one or more of monoclinic niobium-titanium composite oxides selected from the group consisting of: a compound represented by LiₐTi_{1-b}M1_{b}Nb_{2-c}M2_{c}O_{7+δ}, wherein M1 is at least one selected from the group consisting of Zr, Si, and Sn, M2 is at least one selected from the group consisting of V, Ta, and Bi, 0≤a≤5, 0≤b<1, 0≤c<2, and −0.3≤δ≤0.3; and a compound represented by LiₐTi_{1-b}M3_{b+c}Nb_{2-c}O_{7-δ}, wherein M3 is at least one selected from the group consisting of Mg, Fe, Ni, Co, W, Ta, and Mo, 0≤a≤5, 0≤b<1, 0≤c<2, and −0.3≤δ≤0.3.

11. A secondary battery produced by the production method according to claim 1.
